(19) United States
(12) Patent Application Publication
(10) Pub. No.: US 2015/0285647 A1
(43) Pub. Date: Oct. 8, 2015

(54) Planning system and method for planning fieldwork

(71) Applicant: CLAAS E-SYSTEMS KGAA MBH & CO KG, Guetersloh (DE)

(72) Inventors: Lars Peter Meyer zu Helligen, Spenge (DE); Kalle Weiland, Bielefeld (DE)

(21) Appl. No.: 14/666,833

(22) Filed: Mar. 24, 2015

(30) Foreign Application Priority Data
Apr. 2, 2014 (DE) 10 2014 104 619.6

(51) Int. Cl. G01C 21/34; G01C 21/36

(52) U.S. Cl. CPC G01C 21/3407; G01C 21/3667

(57) ABSTRACT

A planning system for planning fieldwork for an agricultural working machine includes a display unit and a data processing unit for processing field-specific data. The data processing unit is programmed to derive at least one reference object from the field-specific data by use an algorithm stored in the data processing unit and to display the at least one reference object on the display unit. At least one reference object is selectable as input information for a working plan for a field by an operator of the planning system. On a basis of the selected at least one reference object, a working plan for the agricultural working machine is created.

### CROSS-REFERENCE TO A RELATED APPLICATION

The invention described and claimed hereinbelow is also described in German Patent Application DE 10 2014 104619.6, filed on Apr. 2, 2014. The German Patent Application, the subject matters of which is incorporated herein by reference, provides the basis for a claim of priority of invention under 35 U.S.C. 119(a)-(d).

### BACKGROUND OF THE INVENTION

The present invention relates to a planning system for planning fieldwork for an agricultural working machine on a field, and to a method for planning fieldwork for an agricultural working machine.

Since the performance of agricultural working machines has continuously improved, the planning and organization of the work sequence for high-performance working machines, such as combine harvesters, forage harvesters, or other agricultural machines, such as fertilizer spreaders or sowers, is becoming increasingly significant. In the planning of the work sequence for an agricultural working machine on a field, the planning of a work route along which the agricultural working machine will travel is of increasing interest, since an appropriate route selection makes it possible, for example, to determine the shortest route required to work the entire field, whereby time and fuel can be saved. The planning of advantageous work routes also includes the planning of appropriate headland regions in which the agricultural working machine can change its direction of travel and, for example, continue working the field parallel to the previous direction of travel.

Document WO 2009/117014 makes known a system and a method for planning a route using an inner processing boundary of a field. In this connection, after an outer field boundary has been established, a desired offset between the outer field boundary and an inner field boundary is determined. A primary reference path disposed at an angle to the outer field boundary is automatically generated for the field using a reference path module, according to which a plurality of secondary reference paths are disposed substantially parallel to the primary reference path on the field.

Boundary points are generated along the reference paths according to the predefined offset from the outer field boundary, which boundary points can be connected in order to create the inner field boundary, as the headland. Although an inner field boundary, as a headland, for example, can be automatically generated in this manner, the known system does not allow an operator to generate reference data on the basis of different field-specific data, which can be subsequently used as input information for planning various tasks.

### SUMMARY OF THE INVENTION

The present invention overcomes the shortcomings of known arts, such as those mentioned above.

To that end, the present invention provides a planning system and a method for an agricultural working machine, which make it easier to generate input information for a subsequent work plan for a field based on field-specific data and thereby make it easier for an operator to plan fieldwork by selecting essential input information.

In an embodiment, the inventive planning system for planning, in an interactive manner, fieldwork for an agricultural working machine comprises a display unit as well as a data processing unit for processing field-specific data. The planning system is set up and designed to generate field-specific data and/or to import specified field-specific data into the data processing unit, derive at least one reference object from the field-specific data using an algorithm stored in the data processing unit and display the at least one reference object on the display unit. The at least one reference object can be selected, as input information for the work plan for the field, by an operator of the planning system, and a work plan for the agricultural working machine is created on the basis of the at least one selected reference object.

The planning system comprises a display unit as well as a data processing unit, which can derive one or more reference objects from field-specific data using an algorithm. Reference objects are displayed on the display unit and thereby make it possible for an operator of the agricultural working machine to make a selection from the displayed reference objects that is appropriate for the further work planning. A selected reference object is used as the input information for creating a work plan for is the agricultural working machine for the corresponding field.

The fact that the operator of the planning system can select reference objects as the input information has the advantage that the operator can determine which reference objects and, therefore, which input information are relevant to the further work planning and, therefore, must be taken into consideration. It is thereby possible to avoid a further-reaching, complex, automatic analysis of the field-specific data and/or reference objects. In addition, the knowledge and experience of the operator, in particular relative to a field to be worked, can be taken into account. It is therefore possible to simplify the generation of a work plan for an agricultural working machine by the interactive step of selecting field-specific reference objects as input information.

In an embodiment, the field-specific data contain information about a field periphery, outer and/or inner field boundaries and/or unusual geographic features of the field. The information on a field periphery, the outer and/or inner field boundaries and/or unusual geographic features stored in the field-specific data can make it easier to generate a work plan, since the information that is needed in order to derive a reference object can be used without further processing of the data.

In an embodiment, the algorithm for deriving a reference object from the field-specific data is an edge detection algorithm. The edge detection algorithm is stored in the data processing device. The field-specific data are prepared by the edge detection algorithm before reference objects are derived in order to generate a graphic depiction, for example, in a linear form, thereby making it easier to derive the reference objects. The reference objects derived by edge detection algorithm can be depicted in the form of lines and/or areas, for example, by displaying the periphery of an area. The edge detection algorithm makes it possible to use simple graphic depictions of a field, thereby avoiding complex data preparation for determining the reference objects since digitized map views or drawings, for example, of land maps or a corresponding field, can be used to generate a work plan.

In an embodiment, a reference object is a reference edge and/or a corner mark, wherein the reference edge can be bounded by two corner marks. The reference edge can be a subsection and/or a portion of a reference object, for example, a section of a field periphery, an outer or inner field boundary. A reference edge can extend between two corner marks and can be bounded thereby. This has the advantage that a defined section and/or portion of a reference object can be derived thereby and displayed. By deriving a reference edge, the input data for generating the work plan is selected and determined more precisely, whereby the accuracy of the work plan is improved.

Advantageously, a reference object is displayed on the basis of an automatic preselection on the display unit. The reference objects, in particular, reference edges, that are depicted on the display unit can be preselected on the basis of predefinable settings, wherein at least a portion of the reference objects derived from the field-specific data can be displayed. A preselection of the displayed reference objects, in particular, reference edges, offers the advantage that only those reference objects that can be used as input information are displayed. A preselection of the displayed reference objects also reduces the work load on the operator, since the preselection of the reference objects reduces the number of possible selections for the operator.

In an embodiment, reference lines for generating work routes, sub-fields, and/or headland regions are created on the basis of the at least one selected reference object. A reference object is depicted in a linear manner, for example as a reference edge, or in a planar manner. A planar reference object can be formed by a selection and connection of a plurality of corner marks. Based on a linear reference object, in particular, a reference edge, that is selected as the input information for the work plan, it is possible to generate a reference line, which is assigned to this reference object and which functions as the basis for planning a work route. A work route for a field is the entire route to be traveled in order to work the field. A work route comprises a plurality of driving paths disposed, for example, substantially parallel on the field.

In addition, the selection of a planar reference object as input information for the work plan makes it possible to create sub-fields and/or headland regions, which are taken into consideration in the work plan. The generation of the work plan is further simplified by the creation of different planning sections, for example, of work routes, subregions and/or headland regions based on the selection of a corresponding reference object by the operator.

Advantageously, reference objects are depicted on the display unit in an interactive manner, wherein the display unit is a touchscreen monitor. By use of the interactive depiction, in particular on a display unit designed as a touchscreen monitor, a displayed reference object can be selected directly on the display unit making it possible to further simplify the generation of a work plan.

The invention further relates to an agricultural working machine comprising a planning system for planning fieldwork, which is designed as described above. The agricultural working machine can comprise a route planning system, which can comprise a planning system according to the invention and/or implement a method for planning according to the invention.

The invention further relates to a method for planning, in an interactive manner, field work for an agricultural working machine. In the method, field-specific data are generated and/or predefined, field-specific data are imported and entered into a data processing unit, at least one reference object is derived from the field-specific data using an algorithm stored in the data processing unit, at least one reference object is displayed on the display unit, at least one reference object is selected by an operator of the planning system as the input information for the planning of the field work and a work plan for the agricultural working machine is generated on the basis of the at least one selected reference object.

Using the method, reference objects derived from field-specific data are displayed on the display unit and thereby make it possible for an operator to make a selection from the displayed reference objects that is appropriate for the further work planning of the relevant field. The selected reference object or objects are used as the input information for creating a work plan for the agricultural working machine for the corresponding field. The mutual interaction between the operator and the planning system, in particular, the selection of reference objects as input information by the operator of the planning system, has the advantage that the operator can determine which reference objects and, therefore, which input information are relevant to the further work planning and, therefore, must be taken into consideration. It is thereby possible to avoid a further-reaching, complex, automatic analysis of the field-specific data and/or reference objects. In addition, the knowledge and experience of the operator, in particular, relative to a field to be worked, can be taken into account. It is therefore possible to simplify the generation of a work plan for an agricultural working machine using the interactive step of selecting field-specific reference objects as input information.

In a method embodiment, the at least one reference object is derived using an edge detection algorithm, wherein a reference edge, which is bounded by two corner marks, in particular, can be generated as the reference object. The reference edge can connect or extend through a plurality of corner marks, wherein the shape of the reference edge is defined by the arrangement of the delimiting and traversed corner marks. The edge detection algorithm makes it possible to use simple graphic depictions of a field, whereby it is possible to avoid complex data preparation for determining the reference objects. The generation of a reference edge, which connects two corner marks and can be bounded thereby, has the advantage that, as a result, a defined section and/or portion can be derived from a reference object and displayed, thereby making it possible to more precisely select and determine the input data for generating the work plan.

In a method embodiment, a display of a reference object on the display unit is based on an automated preselection. Given that a preselection of the reference objects to be displayed is made from among the derived reference objects, it is possible, for example, to display only those reference objects that can be used as input information for generating a work plan, thereby making it possible to further reduce the operator's work load.

The preselection of a reference object is preferably based on the fulfillment of at least one preselection criterium, wherein a preselection criterium can be a length and/or a curvature of a reference object. The preselection criteria are particularly suitable for evaluating the reference objects, for example, a reference edge, that were derived by the edge detection. A length and/or a curvature of a reference object derived by the edge detection algorithm, for example, in the form of a reference edge, can be used particularly effectively here. As a result, a reliable preselection can be made for the display of reference objects that can be used to generate a work plan.

In a method embodiment, reference lines, sub-fields and/or headland regions are generated as input information for generating a work plan on the basis of the at least one selected reference object. A reference object can be depicted in a linear manner, for example, as a reference edge, or in a planar manner, wherein a planar reference object, i.e., a reference area, also can be formed by selecting and connecting a plurality of corner marks. Reference objects can be selected on the basis of their shape and/or arrangement, for example, as a reference line or as a headland region, for the planning of various planning sections, wherein the generation of a work plan can be based on at least one planning section. This has the advantage that the generation of the work plan is further simplified by selecting a corresponding reference object and a planning section associated therewith.

In a method embodiment, the generation of the work plan for the agricultural working machine comprises the generation of information for controlling at least one mounted implement of the agricultural machine. Given that the work plan for the agricultural working machine comprises information for activating mounted implements of the working machine, additional work-related information can be incorporated into the planning and thereby increase the functionality and scope of applications that can be planned by the work plan. This has the advantage that work plans can be generated for a larger variety of agricultural working machines.

### BRIEF DESCRIPTION OF THE DRAWINGS

Further features and advantages of the invention will become apparent from the description of embodiments that follows, with reference to the attached figures, wherein:

FIG. 1: presents a schematic depiction of an agricultural working machine;

FIG. 2: presents a schematic depiction of reference objects of a field;

FIG. 3: presents a schematic depiction of a display of preselected reference objects;

FIG. 4: presents a schematic depiction of driving paths and a subregion after the selection of a reference object; and

FIG. 5: presents a schematic depiction of headland regions, the generation of which is based on the selection of a reference line.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

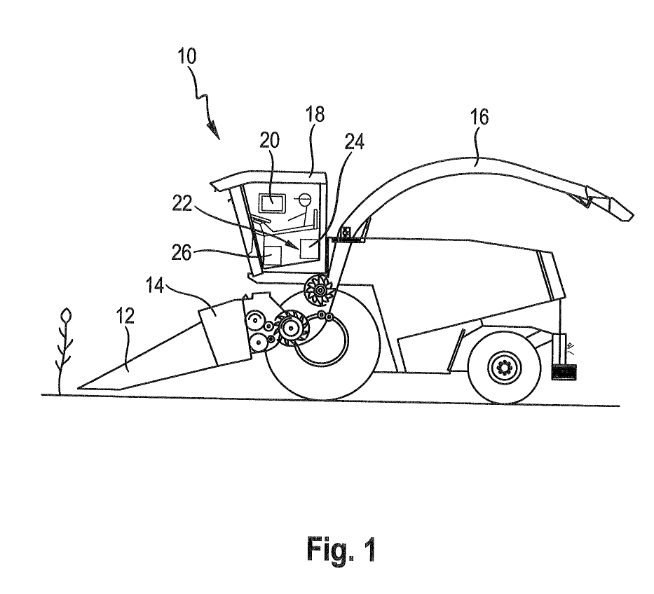

FIG. 1 shows a forage harvester as an example of an agricultural working machine 10, according to the invention. The forage harvester includes among other things a front harvesting attachment 12, an intake conveyor assembly 14, a chopping mechanism and accelerator that feeds the chopped crops to a transfer bend 16. The agricultural working machine 10 used herein is presented only for exemplary purposes and is not meant to limit the term “agricultural working machine” to any particular type. As such, agricultural working machine may be interpreted in the context of the invention to be any working machine that can be used to work a field, such as a combine harvester or a tractor, with or without mounted implements. The agricultural working machine 10 can work a field on the basis of a work plan, wherein a work plan comprises a work route to be traveled along and/or work to be carried out, such as applying a defined amount of fertilizer at specific positions.

A display unit 20 is disposed in a driver's cab 18 of the agricultural working machine 10 for the monitoring and/or control of different functions of the agricultural working machine 10. The work plan is displayed to an operator of the agricultural working machine 10 on the display unit 20. The field-specific work plan for the agricultural working machine 10 is generated and/or stored in a planning system 22 having a data processing unit 24, wherein the planning system 22 comprising the data processing unit 24 is disposed on the agricultural machine 10. The planning system 22 comprising the data processing unit 24 also can be disposed separately from the agricultural working machine 10, for example, in an office, wherein the work plan is transmitted to the agricultural machine 10 via a communication module 26, via a mobile wireless or WLAN connection. The planning system 22, the data processing unit 24 and/or the communication module 26 can be integrated into the display unit 20. The is display unit 20 can comprise a touchscreen monitor for the display and input of information. In the case of a display unit 20 comprising a touchscreen monitor, it is possible to not only display, but also to interact with the displayed information in order to generate or change the work plan.

The planning system 22, in particular, the planning system 22 disposed on the agricultural working machine 10, also comprises further components that are helpful for the generation of a work plan. These include without limitation sensors for detecting and/or generating field-specific data, for example, a position determination device in the form of a GPS receiver. Field-specific data can be data that contain information on the periphery, on the outer and/or inner field boundaries, or unusual geographic features of a field to be worked. Unusual geographic features of a field can be obstacles or driving tracks that must be followed, for example, as part of so-called controlled traffic farming, which must be taken into account when a work plan is generated.

These field-specific data for generating a work plan can already be known, i.e., can be specified data or generated before the work plan is created. Specified data can be stored in the planning system 22, for example, in a memory unit, or can be imported or entered into the planning system 22. The field-specific data are generated, for example, by driving along the outer and/or inner field boundaries. The field-specific data can be present or generated in graphic form, for example, as an image file or a map image and/or in the form of geographic coordinates. In order to permit at least one reference object to be derived from the field-specific data using an algorithm according to the invention, the field-specific data are prepared in a form that is suitable for the use of the algorithm, for example, by visualization in the form of a linear and/or planar depiction of the field-specific data.

In a method according to the invention, the field-specific data are processed by an algorithm stored in the data processing device 24. The algorithm is preferably an edge detection algorithm, which makes it possible to derive reference objects 28 from the field-specific data. The reference objects can be used as input information for generating a work plan.

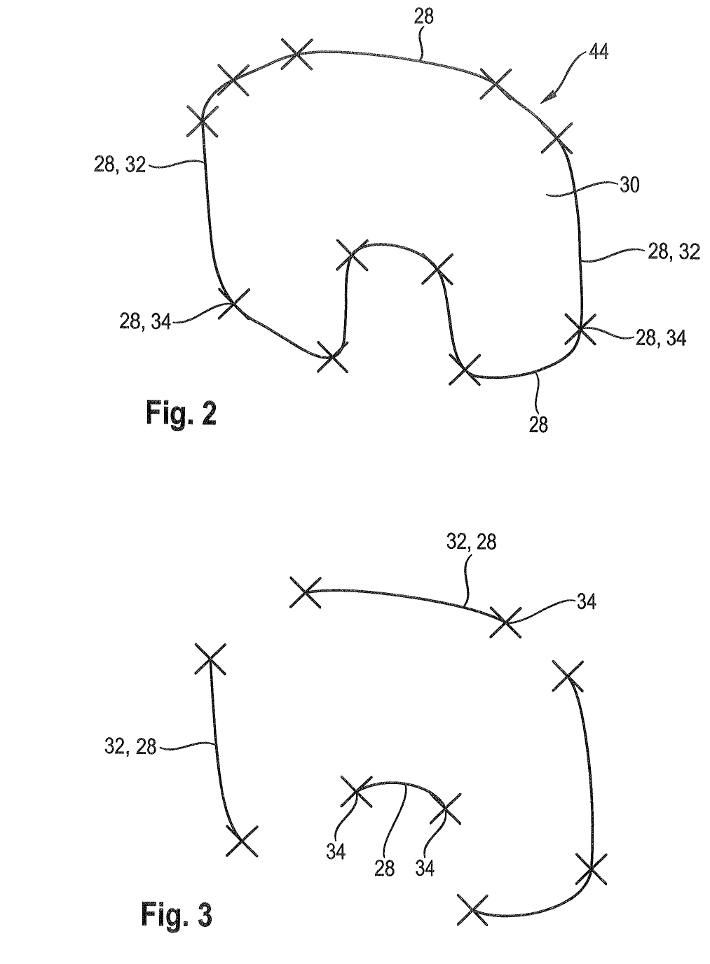

FIG. 2 shows a graphic depiction of a field periphery 44 of a field 30, for which a work plan for the agricultural working machine 10 will be generated. Reference objects, 28 for the field 30 to be worked were derived from the field-specific data, which are present in graphic form, namely the field periphery 44 in this case, i.e., the outer field boundaries, using the edge detection algorithm. The reference objects 28 can be linear reference edges 32 and/or corner marks 34 on the detected field periphery 44. A reference object 28 also can be planar. A reference edge 32 can be bounded by two corner marks 34. A reference object 28, in particular, a reference edge 32, can represent a portion of the field-specific data, for example, the field periphery 44.

The derived reference objects 28 can be shown to the operator of the planning system on the display unit 20 to allow the selection of at least one reference object 28 as input information for generating the work plan. Proceeding from the derived reference objects and the at least one selected reference object 28, various input information can be generated for creating a work plan.

The reference objects 28 derived from the field-specific data can be displayed on the display unit 20 on the basis of an automatic preselection. Using a preselection of the displayed reference objects 28, it is possible, for example, to display only the reference objects 28 that are used for a further generation of the work plan. In addition, the work load of the operator of the planning system can be reduced by displaying preselected reference objects 28, since the operator then no longer needs to make a selection from among all the derived reference objects 28.

FIG. 3 shows a display of reference objects 28, which is based on a preselection, on a display unit 20. In this case, not all of the reference objects 28 derived from the field-specific data, namely, the field periphery 44 in this case, are depicted, but only a reduced number of reference objects 28, in particular reference edges 32 and associated corner marks 34.

A preselection of the reference objects depicted in FIG. 3 can be based on preselection criteria, wherein the preselection criteria can be predefined in a fixed or changeable manner. As a result, an operator of the planning system adapts the preselection criteria to a new field 30 and stores these preselection criteria, for example when generating a work plan for the new field 30, thereby making it possible for these preselection criteria to be predefined for a subsequent generation of a work plan for the same field 30.

A selection criterium for the display of a reference object 28, in particular, a reference edge 32, can be the dimensions, for example, the length or size of the area of the derived reference object. In addition, a curvature of a reference object 28, in particular, at least one edge of a reference object 28, can be used as the preselection criterium. An additional preselection criterium that can be specified is that a derived reference object 28 must be disposed within a defined opening angle relative to a line connecting two adjacent corner marks 34. As a result, a preselected reference object 28 can tend to have a longitudinal extension, for example, in the case of an opening angle of less than 35° on both sides of the connecting line. Limit values and/or value ranges can be specified for the preselection, which must be adhered to with respect to the reference objects 28 so that the reference objects can be used, as input information, to generate a work plan and be displayed for selection.

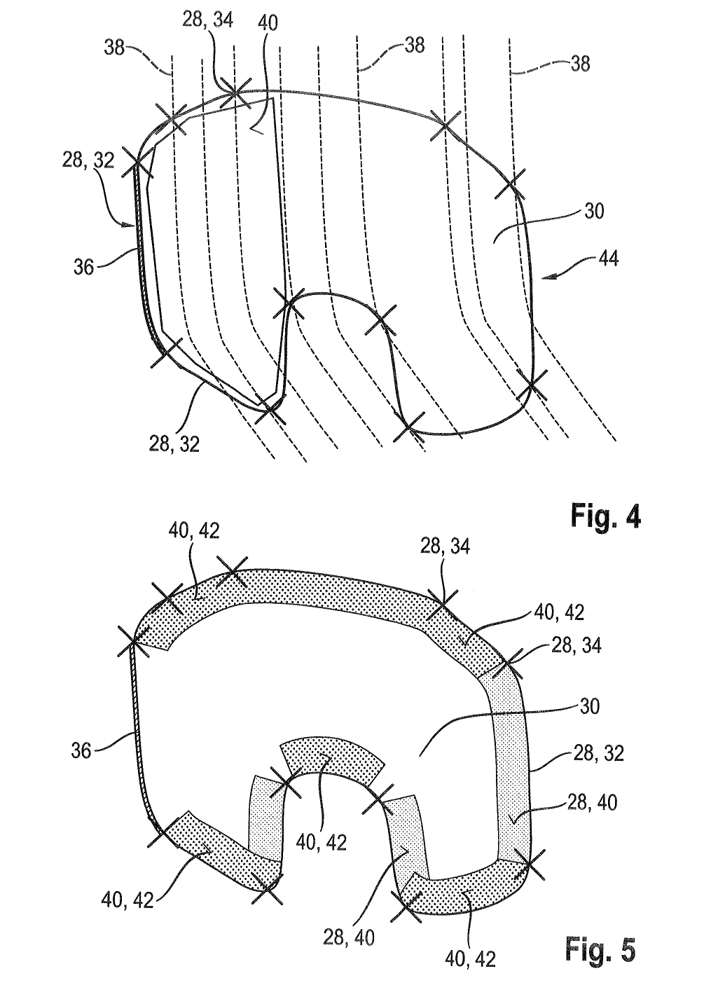

Proceeding from the derived reference objects and the at least one selected reference object 28, various input information can be generated for creating a work plan. FIG. 4 shows the reference objects 28 for the field 30, which have been derived from the field-specific data. A reference object 28 in the form of a reference edge 32 has been selected as a. reference line 36, for example, by an operator, wherein the reference line 36 functions as input information for the further work planning and for the generation of the work plan.

Driving paths 38 are generated and displayed by the planning system 22 on the basis of the reference line 36. The driving paths 38 are disposed substantially parallel to the selected reference line 36, in particular, being distributed on the field 30. The generated driving paths 38 are used to generate a work route for the field 30 to be worked. Further information, for example, machine-specific data such as mounted implements or working widths, can be taken into consideration here. The driving paths 38 are depicted as lines, which are disposed substantially parallel to the reference line 36 and intersect the field periphery 44.

FIG. 4 also shows a reference object 28 in the form of a reference area 40. This reference area 40 is a subregion of the field 30. This reference area 40 can be automatically generated and proposed by the planning system 22, for example, on the basis of preselection criteria, or can be created by the operator. As a result, the operator can appropriately subdivide a field 30 for work, in particular, on the basis of individual work plans and/or combined work plans.

FIG. 5 shows additional reference areas 40, which were generated and displayed by the planning system and are based on the selection of the reference object 28 as a reference line 36. The reference areas 40 show the operator the areas, for selection, which can be used as headland regions 42 in the reference object 28 selected as a reference line 36 (FIG. 4). In this case, the reference areas 40 that can be used as headland regions 42 can be given particular emphasis, for example, in the form of a darker shading. The operator can select the areas to be used as headland regions 42 from among the displayed reference areas 40. The reference areas 40 selected as headland regions 42 are used by the planning system 22 as input information for generating the work plan, wherein the agricultural working machine can turn in the headland regions, for example, in order to enter the next driving path 38 in the opposite direction of travel and continue working the field 30.

The headland regions 42 selected by the operator also can be used, for example, as input information for an automated headland control of the agricultural working machine 10, which can be part of the work plan. The generation of the work plan for the agricultural working machine 10, which is based on the selection of reference objects 28 by the operator, also can comprise the generation of information for controlling mounted implements of the agricultural machine 10. This can be information, for example, for controlling the agricultural working machine 10 and/or for controlling mounted implements of the agricultural working machine 10, such as a fertilizer spreader.

### LIST OF REFERENCE SIGNS

10 agricultural working machine
12 front attachment
14 intake conveyor assembly
16 transfer bend.
18 driver's cab
20 display unit
22 planning system
24 data processing unit
26 communication module
28 reference object
30 field
32 reference edge
34 corner marks
36 reference line
38 driving path
40 reference area
42 headland region
44 field periphery

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A planning system for planning fieldwork for an agricultural working machine, comprising:
a display unit;
a data processing unit for processing field-specific data;
wherein the data processing unit is programmed to derive at least one reference object from the field-specific data by use an algorithm stored in the data processing unit and to display the at least one reference object on the display unit;
wherein at least one reference object is selectable as input information for a working plan for a field by an operator of the planning system; and
wherein on a basis of the selected at least one reference object, a work plan for the agricultural working machine is created.

2. The planning system according to claim 1, wherein the field-specific data contain information selected from the group consisting of a field periphery, outer field boundaries, inner field boundaries, unusual geographic features or a combination.

3. The planning system according to claim 1, wherein the algorithm for deriving the at least one reference object from the field-specific data is an edge detection algorithm.

4. The planning system according to claim 1, wherein the at least one reference object a reference edge, a corner mark or both, and wherein the reference edge is bounded by two corner marks.

5. The planning system according to claim 1, wherein the at least one reference object is displayed on the display unit on the basis of an automatic preselection.

6. The planning system according to claim 1, wherein reference lines for generating work routes, sub-fields or headland regions are created on the basis of the at least one selected reference object, as the input information.

7. The planning system according to claim 1, wherein at least one reference objects are interactively displayed on the display unit and wherein the display unit is a touchscreen monitor in particular.

8. The planning system according to claim 1, wherein the data processing unit generates the field specific data.

9. The planning system according to claim 1, wherein the data processing unit is configured to receive the field specific data.

10. An agricultural working machine comprising a planning system according to claim 1.

11. A method for planning fieldwork for an agricultural working machine, comprising the steps of:
generating field-specific data or importing and entering specified field-specific data into a data processing unit;
deriving at least one reference object from the field-specific data using an algorithm stored in the data processing unit;
displaying the at least one reference object on a display unit;
selecting at least one reference object as input information for a work plan for the field by an operator of the planning system; and
generating a work plan for the agricultural working machine on the basis of the at least one selected reference object.

12. The method according to claim 11, wherein the step of deriving the at least one reference object uses an edge detection algorithm and wherein a reference edge, which comprises at least two corner marks, is generated as the reference object.

13. The method according to claim 11, wherein the step of displaying the at least one reference object on the display unit is based on an automated preselection.

14. The method according to claim 13, wherein the preselection of the at least one reference object is based on the fulfillment of at least one preselection criterium and wherein a preselection criterium is any of the group consisting of a length of a reference object, a curvature of a reference object or both.

15. The method according to claim 12, wherein reference lines sub-fields or headland regions are generated as input information for generating the work plan for the agricultural working machine on the basis of the at least one selected reference object.

16. The method according to claim 12, wherein the generation of the work plan for the agricultural working machine comprises generating information for controlling at least one mounted implement of the agricultural machine.
